(19) United States
(12) Patent Application Publication
(10) Pub. No.: US 2008/0145646 A1
(43) Pub. Date: Jun. 19, 2008

(54) ELECTRONIC DEVICE AND DECOMPOSING METHOD OF ELECTRONIC DEVICE

(75) Inventors: Katsuji EBISU, Kawasaki (JP); Hiroaki DATE, Kawasaki (JP); Michinori KUTAMI, Kawasaki (JP); Shigeharu SUZUKI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/847,838

(22) Filed: Aug. 30, 2007

(30) Foreign Application Priority Data
Dec. 13, 2006 (JP) 2006-335389

(51) Int. Cl. B32B 5/16; B23P 19/04

(52) U.S. Cl. 428/323; 29/426.4

(57) ABSTRACT

A bonding agent and an adhesive sheet for strongly bonding a plurality of components constituting the electronic device for the lifetime of the device, and for lowering a bonding force thereof for easily separating these components on the occasion of decomposing the electronic device. According to the present invention, a plurality of components can be easily decomposed only by executing a heat treatment through bonding of a plurality of components with a bonding agent including a thermo-melting microcapsules which includes a mold releasing agent.

### CROSS-REFERENCE TO RELATED APPLICATIONS

This application is based upon and claims the benefit of priority from the prior Japanese Patent Application No. 2006-335389, filed on Dec. 13, 2006, the entire contents of which are incorporated herein by reference.

### TECHNICAL FIELD

The present invention relates to an electronic device formed by bonding components to form the electronic device with a bonding agent or an adhesive sheet and a decomposing method of the electronic device.

### BACKGROUND OF THE INVENTION

An adhesive sheet is formed by providing an adhesive agent layer on a supporting material and such adhesive sheet is widely used for bonding or the like of electronic components which form an electronic device because such adhesive sheet can be applied easily and has strong adhesive force.

In recent years, when an electronic device is disposed of, the electronic device is required to be decomposed into respective components, so that certain components which adverse effect the environment are properly handled.

An adhesive sheet used for bonding components which form an electronic device is required to have strong adhesive force for the lifetime of the device but must also weaken their bonding force at the time of decomposition thereof.

In view of solving this problem, it has been proposed that thermo-expanding resin particles are previously mixed and dispersed into an adhesive agent layer of an adhesive sheet. Therefore, when the adhesive sheet is separated from the adherend, separation between the adherend and the adhesive sheet is easily accomplished after heating the adhesive sheet to expand the thermo-expanding resin particle (see, for example, Japanese Patent Application Laid-Open No. 1985-252681).

However, the above adhesive sheet does not provide a sufficient separation property because an adhesive force of the bonding agent is not sufficiently reduced.

Moreover, it has also been proposed that a micro-capsule internally including a mold releasing agent is previously included into an adhesive agent layer and that the adhesive sheet is separated from the adherend, when the micro-capsule is broken by pressing the adhesive sheet. After the micro-capsule is broken, the mold releasing agent is released to the adhesive agent layer in order to reduce an adhesive force of the adhesive agent (see, for example, Japanese Patent Application Laid-Open No. 1997-95650).

This adhesive sheet reduces the possibility of leaving residues of adhesive agent on the adherend because an adhesive force of the adhesive agent is reduced with operation of the mold releasing agent. Thereby, adhesive force of the adhesive agent can be lowered. However, in order to attain such an operation effect, the entire surface of the adhesive sheet must be pressed. Therefore, in the case of a large size adhesive sheet and/or an adhesive sheet adhered within narrow corners, other hard to reach areas or like situations which disable the pressing process, easier separation by pressing the adhesive sheet is difficult to realize.

### SUMMARY

The electronic device in accordance with various embodiments of the improved electronic device of the present invention comprises a bonding agent including an adhesive agent, a thermo-melting micro-capsule with a mold releasing agent inside the thermo-melting micro-capsule, and a plurality of components which are bonded to each other by the bonding agent.

### BRIEF DESCRIPTION OF THE DRAWINGS

FIG. 1 is a schematic diagram showing an adhesive sheet for bonding electronic components of an electronic device in accordance with an embodiment of the present invention.

FIG. 2 is a diagram showing a decomposing method of the electronic device in accordance with an embodiment of the present invention.

FIG. 3 is a diagram showing results of the peeling test of the adhesive sheet in accordance with an embodiment of the present invention.

FIG. 4 is a schematic diagram showing the entire part of a mobile phone in accordance with an embodiment of the present invention.

FIG. 5 is a diagram showing an adhesive sheet in accordance with an embodiment of the present invention.

FIG. 6 is a schematic diagram showing a modification example of the adhesive sheet in accordance with another embodiment of the present invention.

FIG. 7 is a diagram showing the results of the peeling test of the adhesive sheet in accordance with another embodiment of the present invention.

FIG. 8 is a schematic diagram showing an electronic device in accordance with another embodiment of the present invention.

FIG. 9 is a diagram showing a decomposing method of electronic device in accordance with another embodiment of the present invention.

FIG. 10 is a schematic diagram showing the entire part of a mobile phone in accordance with another embodiment of the present invention.

### DETAILED DESCRIPTION OF THE PREFERRED EMBODIMENTS

The inventors of the present invention have found that components forming the electronic device can easily be separated respectively by breaking indirectly the microcapsules involving the mold releasing agent rather than requiring direct pressure applied from an outside source.

One aspect of this invention has been proposed on the basis of the investigation explained above and is mainly characterized in that a microcapsule containing a mold releasing agent is formed with a thermo-melting material and the components are bonded with a bonding agent including thermo-melting microcapsules which contain the mold releasing agent or with an adhesive sheet including such bonding agent.

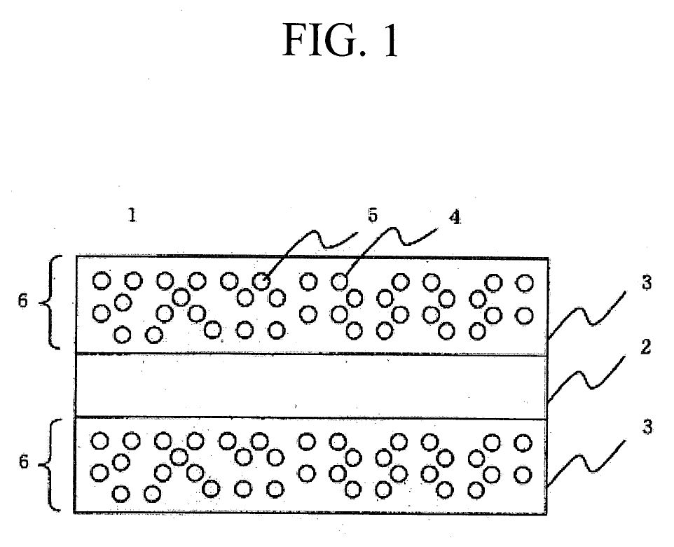

FIG. 1 is a schematic diagram showing a cross-section of an adhesive sheet for bonding components of the electronic device in accordance with an embodiment of the present invention.

The adhesive sheet as the first embodiment shown in FIG. 1 is mainly constituted with a base material 2 and a bonding agent 6. This bonding agent 6 is constituted with an adhesive agent layer 3 and microcapsules 4 involving a mold releasing agent 5.

The base material 2 is a supporting material of the bonding agent 6 and is mainly formed of a thin-leaf material such as a plastic film, a paper, a cloth, an unwoven cloth, a metal foil and laminated materials thereof. Moreover, thickness of the base material 2 is generally set to 500 μm or less, particularly to 5 to 250 μm, but the present invention is not limited thereto. In addition, inductive heat treatment using a high-frequency element can be conducted and heat treatment can also be conducted easily from a separate place by forming the base material 2 from a laminated structure formed of a conductive layer and a magnetic material layer or by allowing the base material 2 to include conductive powder or magnetic powder.

The adhesive agent layer 3 is formed of an adhesive agent to be adhered to a material to be bonded (a bonding object) and it has a 180° peeling bonding force (peeling rate of 300 mm/min) for a stainless steel at 25° C. is 800 g/25 mm or more. Moreover, with the effect of the mold releasing agent 5 explained later, such adhesive force becomes 80 g/25 mm or less. When the bonding force becomes 30 g/25 mm or less, easier and effective peeling can be performed.

As explained above, the adhesive agent layer 3 usually has a strong bonding force of 800 g/25 mm or higher and when it is in contact with the mold releasing agent 5, such bonding force is lowered to 80 g/25 mm or less.

As the adhesive agent layer 3, a material obtained by combining one or more kinds of well-known adhesive agents may be used. For example, the adhesive agent may be one or more of a rubber system, acrylic system, vinyl-alkyl-ether system, silicon system, polyester system, polyamide system, urethane system, or styrene diene-block copolymer system material having improved the creep characteristic by alignment of the thermo-melting resin having the melting point of 200° or less. Moreover, it is also possible to adequately mix an additive such as a cross-linking agent, an adhesive additive agent, a plasticizer, a filling agent, and an anti-aging agent to the adhesive agent. In addition, a rubber system adhesive agent using as a base polymer the natural rubber and various kinds of synthetic rubber and an acryl system adhesive agent using as a base polymer an acryl system polymer using one or more kinds of acryl acid system alkyl ester formed of ester such as acryl acid and methacryl acid having the alkyl group including the number of carbons of 20 or less such as methyl group, ethyl group, propyl group, buthyl group, amyl group, hexyl group, hepthyl group, cyclohexyl group, 2-ethylhexyl group, isooctyl group, isodecyl group, dodecyl group, lauryl group, tridecyl group, pentadecyl group, hexadecyl group, heptadecyl group, octadecyl group, nonadecyl group and eicocyl group may also be used. Moreover, from the viewpoint of achieving remarkable reduction in a bonding force after the heat treatment, it is preferable to use a polymer having the dynamic elasticity of 5×10⁴ to 10⁷ dyn/cm² at the temperature range from normal temperature to 150° C. as the base polymer.

A microcapsule 9 contains a mold releasing agent 5, detailed below, having the function to lower the bonding force of the adhesive agent layer 3 when it is in contact with the adhesive agent layer 3. The microcapsule 4 is made from a thermal melting material.

The microcapsule 4 is made with a thermo-melting material such as vinyliden chloride acrylonitryl copolymer, polyvinyl-alcohol, polyvinyl-buthylar, polymethyl-methacrylate, polyacrylonitryl, vinyliden polychloride, and polysulfon. Particularly, use of synthetic resin such as melamine-formaldehyde resin and isocyanate resin as the microcapsule 4 is very suitable from the viewpoint of excellent water-proof property and solvent-proof property. In addition, use of the microcapsule 4 having the melting point of 60° C. to 150° C. is also suitable. The reason is that if the microcapsule having the melting point under 60° C. is used, a part of the microcapsule 4 is likely to melt naturally, for example, under room temperature even if the heat treatment is not conducted. Moreover, a microcapsule 4 having a melting point of 150° C., is not preferable because a heat treatment at 200° C. or higher is required for thermo-melting of the microcapsule 4 and thereby an ordinary material to be bonded is likely to be thermally deteriorated. Here, the melting point means a solving peak temperature when the bonding object material is measured under a temperature rising rate of 10±1° C./min. conforming to JIS K7121 using a differential scanning calorimeter (DSC).

Moreover, the microcapsule 4 can be manufactured with a well-known technology such as correlation method, interface polymerization method and in-situ polymerization method, etc.

The preferable average particle size of microcapsule 4 is in the range of 1 to 50 μm. The reason is that if the average particle size of microcapsule 4 is 1 μm or less, the quantity of mold releasing agent 4 contained in one microcapsule 4 is reduced, disabling sufficient reduction of the bonding force of the adhesive agent layer 3. Moreover, when the average particle size of microcapsule 4 is 50 μm or more, the microcapsule 4 having no bonding force by itself occupies a greater part of the volume of the adhesive agent layer 3 and thereby the adhesive agent layer 3 can no longer obtain sufficient bonding force.

The mold releasing agent 5 is usually contained, as explained above, within the microcapsule 4 and therefore if the microcapsule 4 is thermally melted, the mold releasing agent 4 is released to the adhesive agent layer 3 to lower the bonding force of the adhesive agent layer 3, for example, to 80 g/25 mm or less.

As the mold releasing agent 5, higher fatty acid, higher fatty acid dielectric material, organo-polysiloxane compound, wax, higher alcohol, mineral oil, animal oil, plant oil, silicone oil, or a mixture of these may also be used. In addition, an oxidation preventing agent and an ultraviolet ray absorbing agent may also be included to these elements. Further, it is desirable for the mold releasing agent 5 to have a lower viscosity. The reason is that if viscosity of the mold releasing agent 5 is too high, the mold releasing agent cannot be scattered sufficiently into the adhesive agent layer 3. Hence, the contact area between the mold releasing agents and the adhesive agent layer 3 becomes small and therefore the bonding force of the adhesive agent layer 3 cannot be sufficiently reduced. In addition, it is preferable that the mold releasing agent 5 is within the range of 1 to 20 wt % in terms of weight percentage for the adhesive agent layer 3 in order to obtain sufficient bonding force and easier peeling property.

The bonding agent 6 is constituted, as explained above, with the adhesive agent layer 3 having the microcapsules 4 containing the mold releasing agent 5 dispersed therein. The bonding agent 6 is provided to both surfaces of the base material 2.

Next, a method for respectively separating components after the components constituting the electronic device are bonded with the adhesive sheet 1 explained above, namely a decomposing method of the electronic device will be explained below. The electronic device in the present invention means any of the devices constituted with a plurality of components such as a personal computer, a mobile phone, an electronic home appliance such as a refrigerator and an electronic oven. Moreover, in this embodiment, the adhesive sheet 1 is explained as an example, but it is also possible to bond the electronic components of the electronic device only with the adhesive agent 6 by eliminating the base material 2 of the adhesive sheet 1.

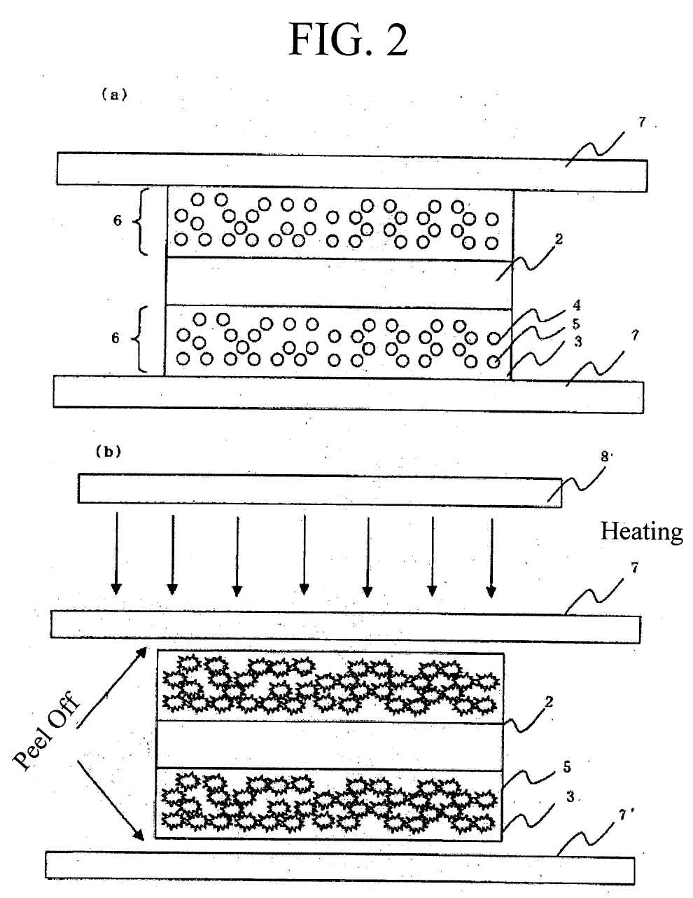

FIG. 2 is a diagram showing a decomposing method of the electronic device in accordance with an embodiment of the present invention.

As shown in FIG. 2(a), a plurality of components 7, 7′ constituting the electronic device are bonded with the adhesive sheet 1. In this case, the bonding force is about 800 g/25 mm or higher.

As shown in FIG. 2(b), when the adhesive sheet 1 is heated using a heating device a, the microcapsule 4 melts and the mold releasing agent 5 contained within the microcapsule 4 is released into the adhesive agent layer 3. Accordingly, the bonding force of the adhesive agent layer 3 is remarkably lowered and thereby the components 6 can be easily peeled from each other. For example, the bonding force becomes equal to 80 g/25 mm or less. Here, the heating device 8 is, for example, a hot plate set to the temperature range of 100 to 250° C. and this heating device 8 heats the adhesive sheet 1 for 1 to 90 seconds. In this embodiment, the heating device 8 is explained as the hot plate but the present invention is never limited thereto and any type of heating device which can heat the adhesive sheet 1 may be used. For example, such heating device can be formed with a material for generating high-frequency element by comprising a magnetic material into the base material 2.

As explained above, in this embodiment, the mold releasing agent 5 for lowering a bonding force of the adhesive agent layer 3 is contained in the thermo-melting microcapsule 4. Therefore, the bonding agent 6 of this embodiment allows for easy separation of the components 7, 7′ constituting an electronic device with sufficient heat treatment. Nonetheless, the bonding agent 6 has usually a strong bonding force throughout the lifetime of the electronic device.

Next, an example, in which the adhesive sheet 1 explained above is manufactured and applied to bonding of components forming an electronic device such as a mobile phone, will be explained.

### FIRST EXAMPLE

Fluorine denaturated silicone oil (FS1265 1000CS, manufactured by Hanwa Industry Co., Ltd.) of 80 weight part is added to 4% aqueous solution of ethylene-anhydrous maleic acid copolymer of 180 weight part adjusted in pH to 6.0 and these mixed elements are emulsified using a homogenizer. Thereafter, this emulsified solution is heated up to 60° C.

Next, melamine of 20 weight part is added to 40% aqueous solution of formaldehyde of 40 weight part and these mixed elements are reacted for 15 minutes under 60° C. The aqueous solution of prepolymer obtained is dropped into the emulsified solution. While the emulsified solution is stirred, hydrochloric acid of 0.1 N is added to adjust pH to 5.3. This solution is heated up to 80° C. and is further stirred for an hour at the stirring rate of 10000 rpm. Thereafter, hydrochloric acid of 0.2 N is added to lower pH up to 3.5. The solution is further stirred for three hours and thereafter it is cooled down to obtain the microcapsule-dispersed solution containing the mold releasing agent. The microcapsules have an average particle size of 10 μm.

The melting point of this microcapsule is about 100° C. as determined by measurement with the DSC.

Next, this microcapsule-dispersed solution is filter-pressed and is then dried up to obtain the powder type microcapsule.

Next, the powder type microcapsule of 30 weight part is mixed into the acryl system adhesive agent of 100 weight part and this mixed agent is coated to a single surface of a polyester film with a thickness of 100 μm to form the bonding agent with a thickness of 50 μm.

Here, a rate of weight of the mold releasing agent for the adhesive agent layer has been set to 10 wt %.

As explained above, an adhesive sheet (first example) has been manufactured.

The 180° peeling test was conducted under the following conditions using the adhesive sheet of the first example.

### Adherend:

Stainless plate (SUS 304, BA finished surface)

### Temperature:

25° C. (room temperature), 110° C. (heated for 10 minutes), 160° C. (heated for 10 minutes)

### Atmospheric Resistance:

Left under atmospheric condition for 30 days

In the peeling test after heat treatments of 110° C. and 160° C., the peeling test has been conducted after the heat treatments for 10 minutes respectively.

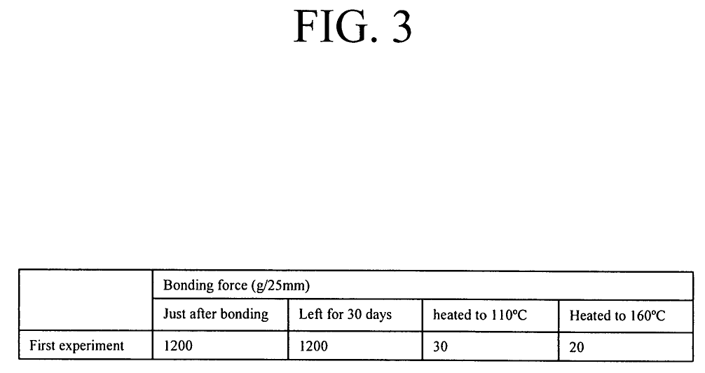

The results of the peeling test of the adhesive sheet of the first example is shown in FIG. 3.

As shown in FIG. 3, a higher bonding force is obtained under the room temperature and a higher peeling property is obtained after the heat treatment.

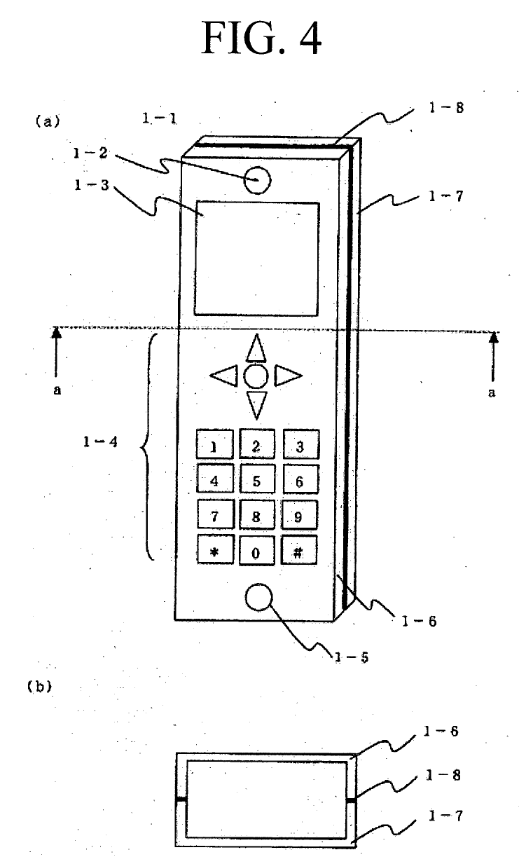

FIG. 4 shows a device example where the adhesive sheet manufactured with the first example is applied for bonding of the upper and lower housings of the mobile phone.

FIG. 4(a) is a schematic diagram showing the entire part of the mobile phone 1-1 in this embodiment.

FIG. 4(b) is a cross-sectional view along the line a-a of the mobile phone 1-1 shown in FIG. 4(a).

The mobile phone 1-1 used in this embodiment is constituted with a speaker 1-2, a display 1-3, an input 1-4, a microphone 1-5, an upper housing 1-6, a lower housing 1-7, and an adhesive sheet 1-8.

The speaker 1-2, display 1-3, input 1-4, microphone 1-5, upper housing 1-6 and lower housing 1-7 are components like those used in well-known mobile phones and the detailed explanation thereof is therefore eliminated here.

The mobile phone 1-1 of this embodiment is characterized in that the upper housing 1-6 and the lower housing 1-7 are bonded with the adhesive sheet 1-8.

The adhesive sheet 1-8 has been formed by coating the bonding agent manufactured with the method explained in the first example to both surfaces of the base material.

Next, experiment have been conducted by putting the mobile phone 1-1 into an oven under the temperature of 150° C. When 10 minutes have passed after the mobile phone has been put into the oven, the mobile phone 1-1 has been separated into the upper housing 1-6 and the lower housing 1-7.

As explained above, the mobile phone 1-1 in this embodiment is easily decomposed into the upper housing 1-6 and lower housing 1-7 as structural components.

Moreover, in the above explanation, the adhesive sheet has been explained as an example of the adhesive sheet 1-8 for bonding the upper housing 1-6 and the lower housing 1-7. In this case, such adhesive sheet is not limited to the sheet manufactured to include the base material. For example, the upper housing 1-6 and the lower housing 1-7 may be bonded only with the bonding agent 6.

In this embodiment, a mobile phone has been explained as an example, but the present invention is not limited thereto. For example, the adhesive sheet 1 may also be used for bonding of the upper housing and lower housing of a notebook size personal computer and it can also be used for any bonding between components of an electronic device.

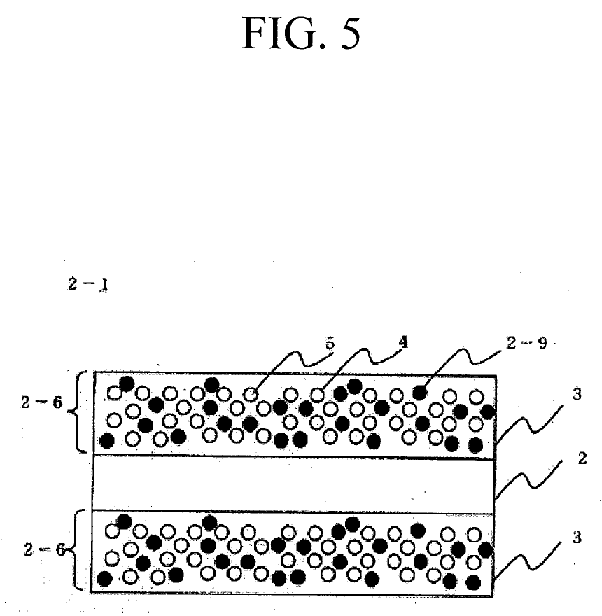

FIG. 5 is a schematic diagram showing a cross-section of the adhesive sheet in accordance with another embodiment of the present invention.

The adhesive sheet 2-1 in this embodiment shown in FIG. 5 is mainly constituted with a base material 2 and a bonding agent 2-6. The bonding agent 2-6 is constituted with an adhesive agent layer 3, microcapsules 4 involving a mold releasing agent 5 and a thermo-expanding particle 2-9.

The thermo-expanding particle 2-9 is dispersed into the adhesive agent layer 3 together with the microcapsules 4 and this particle has the property to expand in its volume up to 5 to 10 times when it is heated.

The bonding agent 2-6 is constituted to include the thermo-expanding particle 2-9. Accordingly, when the adhesive sheet 2-1 bonded to the material is heated with a heating device, the thermo-expanding particle 2-9 expands due to the heat treatment and forms gaps within the adhesive agent layer 3 with a pressing force generated by expansion. In the case where the mold releasing agent 5 released by melting of the microcapsule 4 enters these gaps, a bonding force of the adhesive agent layer 3 is lowered. Moreover, the adhesive sheet 1 of this embodiment also has the effect that the adjacent microcapsule 4 is pressed with thermal expansion and the microcapsule 4 is accelerated in breakdown with such pressing force.

As the thermo-expanding particle 2-9, those which involve a substance showing thermo-expanding property through easier gasification such as isobutene, propane, and pentane, etc. within a shell type substance with the coacervation method and interface polymerization are used. As the shell type substance, the thermo-melting substances, for example, such as vinyliden chloride-acrylonitril copolymer, polyvinyl alcohol, polyvinyl buthylar, polymethyl methacrylate, polyacrylonitril, vinyliden chloride and polysulfon and the substances which are broken by thermal expansion are enough. As the thermo-expanding particle 2-9, for example, a microsphere manufactured by Matsumoto Grease Co., Ltd. may be used.

Moreover, it is more preferable to use the adhesive agent layer 3 which forms gaps with a pressing force caused by expansion of the thermo-expanding particle 2-9.

It is also preferable to use the thermo expanding particle 2-9 which starts thermal expansion in the temperature range of 80 to 220° C. When the thermo-expanding particle which thermally expands at the temperature of 80° C. or lower is used, a part of the thermo-expanding particle 2-9 is likely to thermally expand, even when the heat treatment is not conducted, for example, under room temperature, resulting in reduction of the bonding force of the adhesive agent layer 3. Moreover, when the thermo-expanding particle 2-9 thermally expands at the temperature of 200° C. or higher, heat treatment for 200° C. or higher is required for thermal expansion. Accordingly, such thermo-expanding particle is not preferable because it will thermally deteriorate an ordinary material to be bonded.

Moreover, it is preferable for the adhesive sheet 2-1 to show sufficient bonding force and easier peeling property that the thermo-expanding particle 2-9 has the rate of weight in the percentage of 1 to 20 wt % for the adhesive agent layer 3.

In addition, it is also preferable that the average particle size of the thermo-expanding particle 2-9 is in the range of 1 to 50 μm. When the average particle size of the thermo-expanding particle 2-9 is equal to 1 μm or less, gaps generated by thermal expansion of the thermo-expanding particle 2-9 to widen the adhesive agent layer 3 are too small to provide sufficient effect. Moreover, when the average particle size of the thermo-expanding particle 2-9 is equal to 50 μm or more, this results in the thermo-expanding particle 2-9 occupying a greater part of the volume of the adhesive agent layer 3 and thereby the adhesive agent layer 3 cannot attain sufficient bonding force.

As explained above, the adhesive sheet 2-1 disperses the thermo-expanding particle 2-9 to the adhesive agent layer 3 of the adhesive sheet 1 explained above. Accordingly, the adhesive agent layer 3 is widened with expansion of the thermo-expanding particle 2-9, forming gaps within the adhesive agent layer 3. The mold releasing agent 5 released from the microcapsules 4 diffuses into such gaps to remarkably reduce the bonding force of the adhesive agent layer 3.

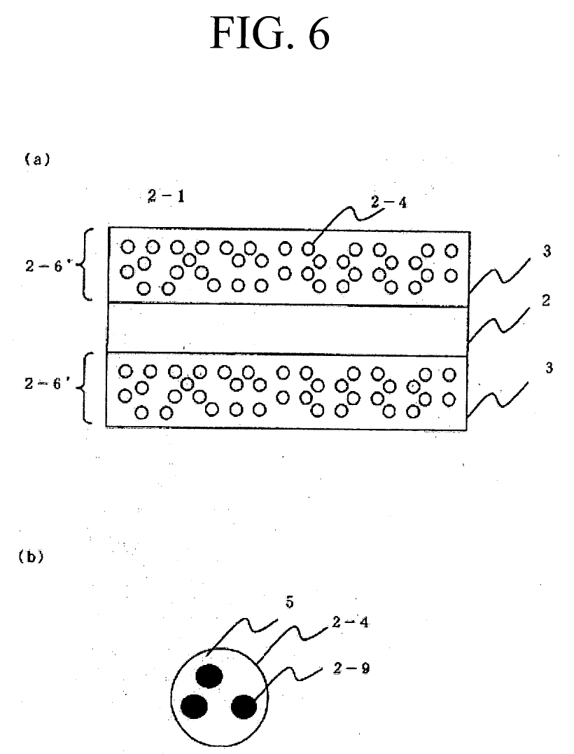

FIG. 6 is a diagram showing an example of modification of the adhesive sheet 2-1.

The adhesive sheet 2-1 shown in FIG. 6 is formed so that the microcapsule 2-4 contain the thermo-expanding particle 2-9 and mold releasing agent 5 as shown in FIG. 6(b).

In the case where the microcapsule 2-4 is constituted as explained above, the microcapsule 2-4 can be broken from within when the thermo-expanding particle 2-9 is thermally expanded by heating. In addition, the effect for pressing the mold releasing agent 5 from within the microcapsule 2-4 can also be detected and thereby release of the mold releasing agent 5 can be accelerated and diffusion thereof into the adhesive agent layer 3 is also accelerated.

Moreover, it is preferable that a ratio of the mold releasing agent 5 is more enhanced than the thermo-expanding particle 2-9 in the microcapsule 2-4. The reason is that the bonding force of the adhesive agent layer 3 may be lowered more effectively in this case.

In addition, it is also possible that the microcapsule 2-4 contains the thermal bonding particle 2-9 and mold releasing agent 5 as shown in FIG. 6, while the thermo-expanding particle 2-9 is dispersed into the adhesive agent layer 3 as shown in FIG. 5. In this case, gaps are mainly formed within the adhesive agent layer 3 with the thermo-expanding particle 2-9 dispersed into the adhesive agent layer 3 and breakdown of the microcapsule 2-4, acceleration of release of the mold releasing agent 5, and diffusion thereof into the adhesive agent layer 3 can be conducted mainly with the thermo-expanding particle 2-9 within the microcapsule 4.

As explained above, the adhesive sheet 2-1 in this embodiment is capable of increasing more effectively the diffusion property of the mold releasing agent 5 into the adhesive agent layer 3 during the heat treatment because the thermo-expanding particle 2-9 is dispersed into the adhesive agent layer 3 and microcapsule 4.

Next, an example, where the adhesive sheet 2-1 explained in this embodiment is manufactured and this adhesive sheet 2-1 is applied for bonding components forming an electronic device, will be explained below.

### SECOND EXAMPLE

Ion exchange water of 600 g, sodium chloride of 150 g, adipic acid-diethanolamine condensated compound of 1.5 g and 20% aqueous solution of colloidal silica of 40 g are mixed and this mixed solution is adjusted to pH of 3.7 to 4.1 with sulfuric acid as the water phase.

Next, acrylonitril of 180 g, methacrylonitril of 105 g, methyl-methacryl acid of 15 g, ethylene grycol dimethacryl acid of 1.5 g, polyoxyethylene-nonylphenyl-ether acrylate of 2.0 g, isopethane of 75 g, and azobith-isobuthyl-nitril of 1 g are mixed, stirred, and dissolved to form the oil phase.

Next, the water phase and oil phase manufactured as explained above are mixed and stirred for 5 minutes with a TK homo-mixer at a stirring rate of 20000 rpm to form the suspension.

Next, the suspension is transferred to a 1.5 L pressurizing reactor for nitrogen substitution. Thereafter, the suspension is reacted for 15 hours at the temperature of 70° C., while it is stirred.

The reaction product obtained is filtered and dried to form the thermo-expanding particle having an average particle size of 10 μm.

Next, the thermo-expanding particle is mixed with the microcapsule powder and the acryl system adhesive agent which have been manufactured with the processes similar to that of the first example to manufacture the adhesive sheet (second example). The thermo-expanding particle has the thermo-expanding start temperature of 100° C. and is included therein in 10 wt % for the adhesive agent layer.

### THIRD EXAMPLE

Fluorine denaturated silicone oil (FS1265 1000CS, manufactured by Hanwa Industry Co., Ltd.) of 80 weight part is added to 4% aqueous solution of an ethylene-anhydrous maleic acid copolymer of 180 weight part adjusted in pH to 6.0 and these mixed elements are emulsified using a homogenizer. Thereafter, this emulsified solution is mixed with the thermo-expanding particle manufactured in the second example of 100 weight part and dispersed. Moreover, the emulsified solution is heated up to 60° C.

In addition, melamine of 20 weight part is added to the 40% aqueous solution of formaldehyde of 40 weight part and these mixed elements are reacted for 15 minutes under 60° C. The aqueous solution of prepolymer obtained is added into the emulsified solution. While the emulsified solution is stirred, hydrochloric acid of 0.1N is added to adjust pH to 5.3. This solution is heated up to 80° C. and is further stirred for an hour at a stirring rate of 10000 rpm. Thereafter, hydrochloric acid of 0.2N is also added to lower pH up to 3.5. The solution is further stirred for three hours and thereafter it is cooled down to obtain the microcapsule-dispersed solution containing the mold releasing agent with an average particle size of 10 μm.

The melting point of the shell material of the microcapsule has been measured as 100° C. with the DSC.

Next, this dispersing solution is filter-pressed and is then dried to form the microcapsule powder including the thermo-expanding particle and mold releasing agent.

Thereafter, the adhesive sheet (third example) has been manufactured with the processes similar to that in the first example.

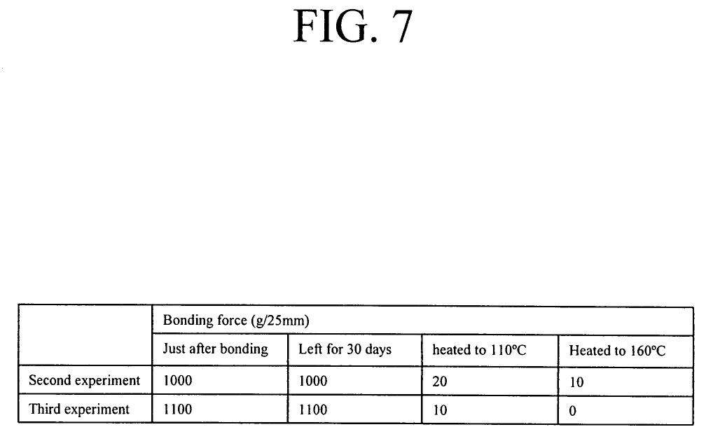

Results of a peeling test of this adhesive sheet in accordance with another embodiment of the present invention are shown in FIG. 7.

As shown in FIG. 7, the bonding force under room temperature can be lowered in the second example in comparison with the first example but the bonding force after the heat treatment can be lowered.

In the third example, higher bonding force can be attained under room temperature and the bonding force of the adhesive agent layer after heat treatment can be lowered remarkably.

Next, the adhesive sheets manufactured with the methods of the second and third examples are respectively applied to the adhesive sheet 1-8 of the mobile phone 1-1 shown in FIG. 4.

An experiment has also been conducted by putting the mobile phone 1-1 in this embodiment into an oven at the temperature of 150° C. The mobile phones 1-1 to which the adhesive sheets manufactured with the methods of the second and third examples have been separated into the upper housing 1-6 and the lower housing 1-7 after 10 minutes of heating in the oven.

As explained above, the mobile phone 1-1 in this embodiment can easily be decomposed to the upper housing 1-6 and the lower housing 1-7 as the structural components.

In above explanation, the adhesive sheet has been explained as an example as the adhesive sheet 1-8 bonding the upper housing 1-6 and the lower housing 1-7, but such adhesive sheet is not required to be processed as the adhesive sheet including the base material. For example, the upper housing 1-6 and the lower housing 1-7 may be bonded only with the bonding agent 2-6 and bonding agent 2-6′ attained by removing the base material 2 from the adhesive sheet 2-1 shown in FIG. 5.

Moreover, a mobile phone has been explained as an example in this embodiment, but the present invention is not limited thereto. For example, the present invention may be applied for bonding between the upper housing and the lower housing of a notebook size personal computer and also applied to any type of bonding among electronic components used for electronic devices.

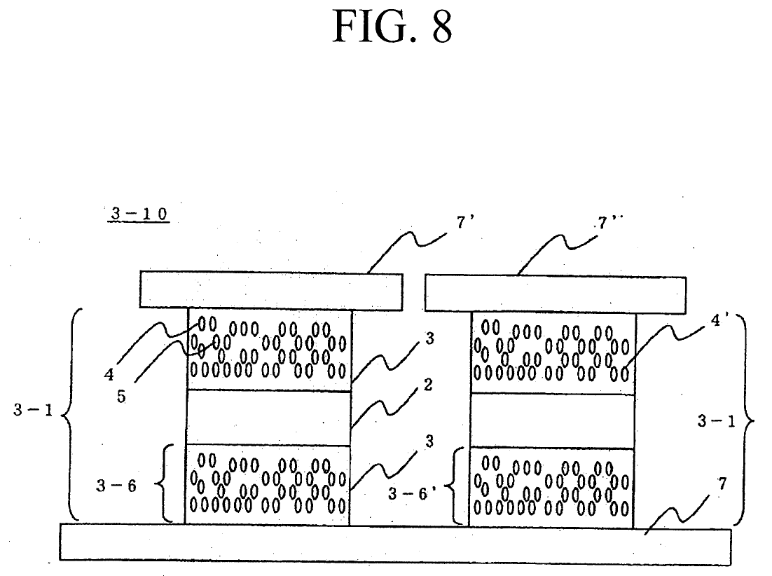

FIG. 8 is a schematic diagram showing an electronic device 3-10 in accordance with another embodiment of the present invention.

The electronic device 3-10 shown in FIG. 8 is mainly constituted with a first component 7, a second component 7′, a third component 7″, a first adhesive sheet 3-1 and a second adhesive sheet 3-1′.

The first and second components 7 and 7′ are bonded with the first adhesive sheet 3-1, while the first and third components 7 and 7″ are bonded with the second adhesive sheet 3-1′. Namely, the electronic device 3-10 in this embodiment includes a plurality of bonding areas.

Moreover, the first and second adhesive sheets 3-1, 3-1′ are similar to the adhesive sheet 1 of FIG. 1 or adhesive sheet 2-1 of FIG. 5 and FIG. 6.

A melting point of the microcapsule 4 of the first adhesive sheet 3-1 is different from that of the microcapsule 4′ of the second adhesive sheet 3-1′. For example, the melting point of the second microcapsule 4′ is set higher than the melting point of the first microcapsule 4.

Next, a method for bonding the first and second components 7, 7′ and first and third components 7, 7″ respectively constituting the electronic device 3-10 with the first and second adhesive sheets 3-1, 3-1′ explained above and thereafter peeling the first and second components 7,7, and first and third components 7, 7″, namely a decomposing method of the electronic device 3-10 will be explained below. The electronic device 3-10 means any of the devices constituted with a plurality of electronic components such as a personal computer, a mobile phone, an electronic home appliance such as a refrigerator and an electronic oven, etc. Moreover, in this embodiment, the first and second adhesive sheets 3-1, 3-1′ are explained as an example but the components of the electronic device 3-1 may be bonded only with the single adhesive agents 3-6, 3-6′ by eliminating the base material 2 of the first and second adhesive sheets 3-1, 3-1′.

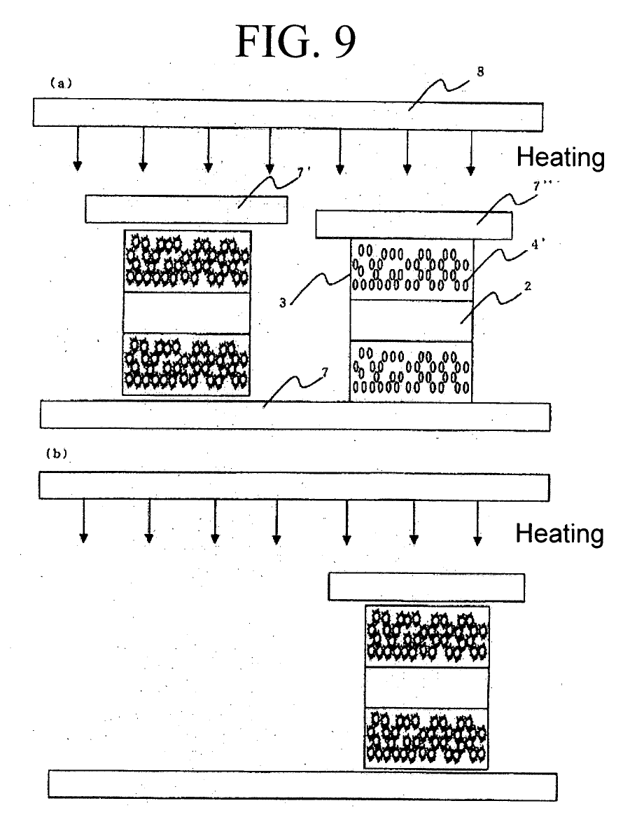

FIG. 9 is a diagram showing a decomposing method of the electronic device 3-1 as shown in FIG. 8.

The bonding forces of the first and second adhesive sheets 3-1, 3-1′ are respectively set to 800 g/25 mm or more.

As shown in FIG. 9(a), the electronic device 3-10 is heated to a first temperature using the heating device B. Thereby, the microcapsule 4 of the adhesive sheet 3-1 melts and the mold releasing agent 5 contained within the microcapsule 4 is released into the adhesive agent layer 3. Here, the first temperature is set to the temperature which is enough for melting of the first microcapsule 4 of the first adhesive sheet 3-1 and for not melting the second microcapsule 4′ of the second adhesive sheet 3-1′. Therefore, the bonding force of the adhesive agent layer 3 is remarkably lowered and thereby the first and second components 7, 7′ can be easily peeled with each other. For example, the bonding force becomes equal to 80 g/25 mm or less. Here, the heating device 8 is, for example, a hot plate set to the temperature range of 100 to 250° C. and this heating device 8 heats the adhesive sheet 1 for 1 to 90 seconds. In this embodiment, the heating device 8 is explained as a hot plate but the present invention is not limited thereto and any type of heating device which can heat the adhesive sheet 1 may be used. For example, such heating device can be formed with a material for generating a high-frequency element by including a magnetic material into the base material 2.

As explained above, in this embodiment, the mold releasing agent 5 which lowers the bonding force of the adhesive agent layer 3 of the single bonding agent 3-6 is contained in the thermo-melting microcapsule 4 which melts at the first temperature. Accordingly, although the bonding agent 3-6 in this embodiment usually has a strong bonding force throughout the lifetime of the device, the first and second components 7, 7′ constituting the electronic device can easily be peeled only by heating these elements up to the first temperature.

Meanwhile, the second microcapsule 4′ of the second adhesive sheet 3-1′ does not melt at the first temperature but melts at the second temperature higher than the first temperature. Accordingly, as shown in FIG. 9(a), the bonding force of the single bonding agent 3-6′ is not reduced at this time and the first and third components 7, 7″ are not separated. That is, only the second component 7′ can be collected by heat treatment under the first temperature.

Next, the electronic device 3-10 is heated up to the second temperature higher than the first temperature using the heating device 8 as shown in FIG. 9(b). Thereby, the second microcapsule 4′ of the second adhesive sheet 3-1′ melts and the mold releasing agent 5 contained in the second microcapsule 4′ is released into the adhesive agent layer 3. Here, the second temperature is set to the temperature for melting the second microcapsule 4′ of the second adhesive sheet 3-1′. Therefore, the bonding force of the adhesive agent layer 3 is lowered, and the first and third components 7,7″ can be peeled easily from each other. For example, the bonding force is reduced to 80 g/25 mm or less.

As explained above, the mold releasing agent 5 for lowering the bonding force of the adhesive agent layer 3 of the second bonding agent 3-1′ is contained in the thermo-melting microcapsule 4′ which melts at the second temperature. Accordingly, although the second bonding agent 3-1′ in this embodiment has strong bonding force throughout the lifetime of the device, the first and third components 7, 7″ constituting the electronic device can be easily peeled from each other only by heating the device up to the second temperature. Namely, the first and third components 7, 7′ can respectively be collected with the heat treatment under the second temperature.

In addition, the melting point of the first microcapsule 4 of the first adhesive sheet 3-1 for bonding the first and second components 7, 7′ is set different from the melting point of the second microcapsule 4′ of the second adhesive sheet 3-1′ for bonding the second and third components 7, 7″. With such structure, peeling of the first and second components 7, 7′ is conducted at a different time from that of the peeling of the first and third components 7, 7″. Accordingly, on the occasion of decomposing the electronic device 3-10, the components constituting the first electronic device 3-1 can be separately collected.

Next, a peeling experiment of the first, second and third components 7, 7′, and 7″ after manufacture of the electronic device 3-10 including a plurality of bonding areas explained in FIG. 8 and FIG. 9 will then be explained below.

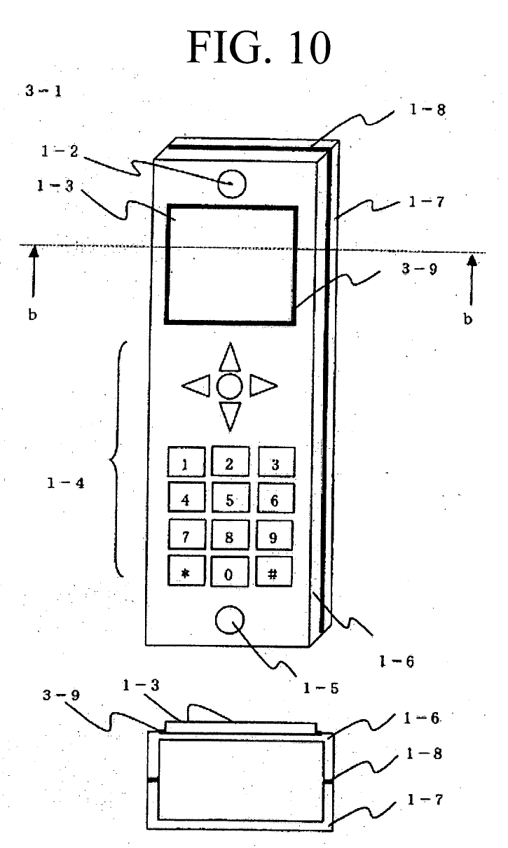

FIG. 10 is a schematic diagram showing the entire part of a mobile phone in accordance with another embodiment of the present invention.

The mobile phone 3-1 shown in FIG. 10 is different from the mobile phone 1-1 explained with reference to FIG. 4 in the point that a display 1-3 is bonded with an upper housing 1-6 with an adhesive sheet 3-9.

Here, the adhesive sheet 1-E is the adhesive sheet 1, as shown in FIG. 1, formed by coating the adhesive agent manufactured in the first example to both surfaces of the base material and this adhesive sheet 1-8 has a melting point of 100° C.

On the other hand, the adhesive sheet 3-9 has been manufactured by changing the stirring time at 80° C. in the first example to 1.5 hours from one(1) hour and the microcapsule of this sheet has a melting point of 120° C.

Namely, the bonding force of the adhesive sheet 1-8 for bonding the upper housing 1-6 and the lower housing 1-7 of the mobile phone 3-1 can be lowered by heating the mobile phone up to 100° C., while the bonding force of the adhesive sheet 3-9 for bonding the display 1-3 and the upper housing 1-6 can be lowered by heating the mobile phone up to 120° C.

Next, the mobile phone 3-1 in this embodiment has been put into an oven under the temperature of 110° C. Thereby, the upper housing 1-6 and the lower housing 1-7 of the mobile phone 3-1 have been separated after 10 minutes.

Next, the upper housing 1-6 where the display 1-3 is bonded with the adhesive sheet 3-9 has been put into the oven under the temperature of 160° C. Thereby, the display 1-3 and the upper housing 1-6 have been separated after 10 minutes.

As explained above, the mobile phone 3-1 in this embodiment can be decomposed at different times into the upper housing 1-6 and lower housing 1-7, and into the upper housing 1-6 and display 1-3 as the structural components. Therefore, the display 1-3, upper housing 1-6 and lower housing 1-7 of the mobile phone 3-1 can be collected separately.

In above explanation, the adhesive sheet including the base material has been explained as an example as the adhesive sheet 1-8 and the adhesive sheet 3-9 but the present invention can also be applied to the sheet processed to the adhesive sheet including the base material. For example, bonding between the upper housing 1-6 and lower housing and bonding between the display 1-3 and upper housing can be realized only with the bonding agent after removing the base material from the adhesive sheet.

In addition, an example of manufacturing the adhesive sheets 1-8 and 3-9 with the method explained in the first example has been explained above, but it is also possible to introduce the sheet manufactured with the method explained in the second example and third example. Moreover, an example where the adhesive sheets 1-8 and 3-9 are manufactured with the similar method has been explained but it is also possible to use the sheets manufactured with different methods, for example, to use the adhesive sheet 1-8 manufactured with the method of the first example and the adhesive sheet 3-9 manufactured with the method of the second example or third example.

In addition, a mobile phone has been explained as an example in this embodiment, but the present invention is not limited thereto. For example, the adhesive sheet 1-8 may be used for bonding between the upper housing and the lower housing of a notebook size personal computer and the adhesive sheet 3-9 may be used for bonding between the mouse pad and the upper housing of the notebook size personal computer. Namely, the present invention can be applied to any type of bonding among components of electronic devices.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An electronic device comprising:
a bonding agent including
an adhesive agent,
a thermo-melting micro-capsule with a mold releasing agent inside the thermo-melting micro-capsule;
a plurality of components which are bonded to each other by the bonding agent.

2. The electronic device according to claim 1,
wherein the bonding agent is located on a plurality of surfaces of a base material.

3. The electronic device according to claim 2,
wherein the base material includes a conductive material or a magnetic material.

4. The electronic device according to claim 1,
wherein the bonding agent includes a thermo-expanding particle.

5. The electronic device according to claim 1,
wherein the thermo-melting micro-capsule includes a thermo-expanding particle inside the thermo-melting micro-capsule.

6. The electronic device according to claim 4,
wherein the thermo-expanding particle begins thermal expansion at a temperature in a range from 80 to 200° C.

7. The electronic device according to claim 1,
wherein the thermo-melting micro-capsule has a melting point in a range of 60 to 150° C.

8. An electronic device comprising:
a first bonding agent including
an adhesive agent,
a first thermo-melting micro-capsule having a first melting point with a mold releasing agent inside the first thermo-melting micro-capsule,
a plurality of first components which are bonded to each other by the first bonding agent;
a second bonding agent including
the adhesive agent,
a second thermo-melting micro-capsule having a second melting point with the mold releasing agent inside the second thermo-melting micro-capsule,
a plurality of second components which are bonded to each other by the second bonding agent.

9. The electronic device according to claim 8,
wherein at least one of the first bonding agent and the second bonding agent is located on surfaces of a base material.

10. The electronic device according to claim 9,
wherein the base material includes a conductive material or a magnetic material.

11. The electronic device according to claim 8,
wherein at least one of the first bonding agent and the second bonding agent includes a thermo-expanding particle.

12. The electronic device according to claim 8,
wherein a thermo-expanding particle is inside at least one of the first thermo-melting micro-capsule and the second thermo-melting micro-capsule.

13. A decomposing method for decomposing an electronic device comprising:
a decomposing step for decomposing the electronic device to a plurality of components by heating the electronic device to a set temperature;
wherein the electronic device comprises a bonding agent including
an adhesive agent,
a thermo-melting micro-capsule having a first melting point with a mold releasing agent inside the thermo-melting micro-capsule,
wherein the plurality of components are bonded to each other by the bonding agent prior to the decomposing step;
wherein said set temperature is equal to or greater than said first melting point.

14. The decomposing method for decomposing an electronic device according to claim 13,
wherein the bonding agent includes a thermo-expanding particle.

15. The decomposing method for decomposing an electronic device according to claim 13,
wherein a thermo-expanding particle is inside the thermo-melting micro-capsule.

16. A decomposing method for decomposing an electronic device comprising:
a first decomposing step for decomposing the electronic device to a plurality of first components by heating the electronic device to a first set temperature;
a second decomposing step for decomposing the electronic device to a plurality of second components by heating the electronic device to a second set temperature;
wherein the electronic device comprises a first bonding agent including
an adhesive agent,
a first thermo-melting micro-capsule having a first melting point with a mold releasing agent inside the first thermo-melting micro-capsule,
a second bonding agent including
the adhesive agent,
a second thermo-melting micro-capsule having a second melting point with the mold releasing agent inside the second thermo-melting micro-capsule,
wherein the plurality of first components are bonded to each other by the first bonding agent, and the plurality of second components are bonded to each other by the second bonding agent;
wherein the first set temperature is equal to or greater than said first melting point;
wherein the second set temperature is equal to or greater than said second melting point.

17. The decomposing method for decomposing an electronic device according to claim 16,
wherein the second melting point is higher than the first melting point.

18. The decomposing method for decomposing an electronic device according to claim 16,
wherein at least one of the first bonding agent and the second bonding agent includes a thermo-expanding particle.

19. The decomposing method for decomposing an electronic device according to claim 18,
wherein a thermo-expanding particle is inside at least one of the first thermo-melting micro-capsule and the second thermo-melting micro-capsule.

20. The decomposing method for decomposing an electronic device according to claim 16,
wherein at least one of the first thermo-melting micro-capsule and the second thermo-melting micro-capsule includes a thermo-expanding particle.
